(19) United States
(12) Patent Application Publication
(10) Pub. No.: US 2004/0107203 A1
(43) Pub. Date: Jun. 3, 2004

(54) Architecture for a data cleansing application

(75) Inventors: Douglas R. Burdick, Ithaca, NY (US); Robert J. Szczerba, Endicott, NY (US); Joseph H. Visgitus, Endwell, NY (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Lockheed Martin Corporation

(21) Appl. No.: 10/308,788

(22) Filed: Dec. 3, 2002

(51) Int. Cl. G06F 17/00; G06F 7/00

(52) U.S. Cl. 707/101

(57) ABSTRACT

A system cleanses data. The system includes an input component, a pre-process component, an automated learning component, and a post-process component. The input component receives a collection of records. The pre-process component formats the collection of records and creates a plan for cleansing the collection of records. The automated learning component performs the plan and modifies the plan based on feedback from intermediate steps within the plan. The post-process evaluation component evaluates the result of the automated learning component. The post-process component determines whether to accept the result or to feed back the result to the automated learning component.

### FIELD OF THE INVENTION

The present invention relates to a system for cleansing data, and more particularly, to an architecture for a data cleansing application.

### BACKGROUND OF THE INVENTION

In today's information age, data is the lifeblood of any company, large or small; federal, commercial, or industrial. Data is gathered from a variety of different sources in various formats, or conventions. Examples of data sources may be: customer mailing lists, call-center records, sales databases, etc. Each record from these data sources contains different pieces of information (in different formats) about the same entities (customers in the example case). Each record from these sources is either stored separately or integrated together to form a single repository (i.e., a data warehouse or a data mart). Storing this data and/or integrating it into a single source, such as a data warehouse, increases opportunities to use the burgeoning number of data-dependent tools and applications in such areas as data mining, decision support systems, enterprise resource planning (ERP), customer relationship management (CRM), etc.

The old adage “garbage in, garbage out” is directly applicable to this environment. The quality of the analysis performed by these tools suffers dramatically if the data analyzed contains redundant values, incorrect values, or inconsistent values. This “dirty” data may be the result of a number of different factors including, but certainly not limited to, the following: spelling errors (phonetic and typographical), missing data, formatting problems (incorrect field), inconsistent field values (both sensible and non-sensible), out of range values, synonyms, and/or abbreviations (as illustrated in FIG. 1). Because of these errors, multiple database records may inadvertently be created in a single data source relating to the same entity or records may be created which don't seem to relate to any entity. These problems are aggravated when the data from multiple database systems is merged, as in building data warehouses and/or data marts. Properly combining records from different formats becomes an additional issue here. Before the data can be intelligently and efficiently used, the dirty data needs to be put into “good form” by cleansing it and removing these mistakes.

Thus, data cleansing necessarily involves the identifying of similarities between fields in different records. The simplest approach for determining which records have “similar” values for a particular field would be to define only identical values to be “similar”. If two records have the same value for the field, they would be considered to have similar values. Otherwise, they would not. This approach is very prone to “noise,” or errors present in the data causing differences between records describing the same object (i.e., causes records to have different values for the field). Most conventional architectures for implementing these approaches simply process the record collection.

A typical cleansing process runs all of the steps in a fixed order to completion, and is considered conceptually to be a “black box” where record data is presented for input to the data cleansing process, and the cleansed record data is returned at completion. There is no information about how the results of the cleansing process were obtained. As a result, any feedback on the results of the cleansing process could only take place after the entire process has completed. Feedback before completion would be useful for large record collections, where the cleansing process may take a substantial amount of time to complete.

### SUMMARY OF THE INVENTION

A system in accordance with the present invention defines an architecture for performing data cleansing on a collection of records. The record collection may come from one or more initial sources. The architecture supports a learning system that refines the cleansing process and improves the quality of the computed results. The architecture also provides visibility of intermediate steps of the cleansing process, as well as integration of feedback during execution of the data cleansing algorithm.

The architecture supports a data cleansing process for record collections from one or more sources. The architecture incorporates support for additional information along with the record collection. This additional information is used to support a learning system to improve the quality of the results of the data cleansing process. This additional information may be generated by the cleansing process itself or provided as input external to the data cleansing process. The architecture also supports iteration of either particular intermediate steps of the cleansing process or the entire process.

The integration of these concepts creates a data cleansing architecture that produces a transparent data cleansing process. Information about how the results were obtained may now be included with the cleansed output. Feedback regarding results of intermediate steps within the cleansing process may also be used by the learning system to improve the process “on-the-fly”. This learning “as you go” system allows the data cleansing system to produce much more accurate and efficient results than could be obtained previously.

### BRIEF DESCRIPTION OF THE DRAWINGS

The foregoing and other advantages and features of the present invention will become readily apparent from the following description as taken in conjunction with the accompanying drawings, wherein:

FIG. 1 is a schematic representation of the performance of a part of an example system for use with the present invention;

FIG. 2 is a schematic representation of part of an example system in accordance with the present invention;

FIG. 3 is a schematic representation of another part of an example system in accordance with the present invention;

FIG. 4 is a schematic representation of still another part of an example system in accordance with the present invention;

FIG. 5 is a schematic representation of yet another part of an example system in accordance with the present invention;

FIG. 6 is a schematic representation of one example part of a system for use with the present invention;

FIG. 7 is a schematic representation of another example part of a system for use with the present invention;

FIG. 8 is a schematic representation of still another example part of a system for use with the present invention;

FIG. 9 is a schematic representation of yet another example part of a system for use with the present invention;

FIG. 10 is a schematic representation of still another example part of a system for use with the present invention;

FIG. 11 is a schematic representation of yet another example part of a system for use with the present invention; and

FIG. 12 is a schematic representation of still another part of an example system in accordance with the present invention.

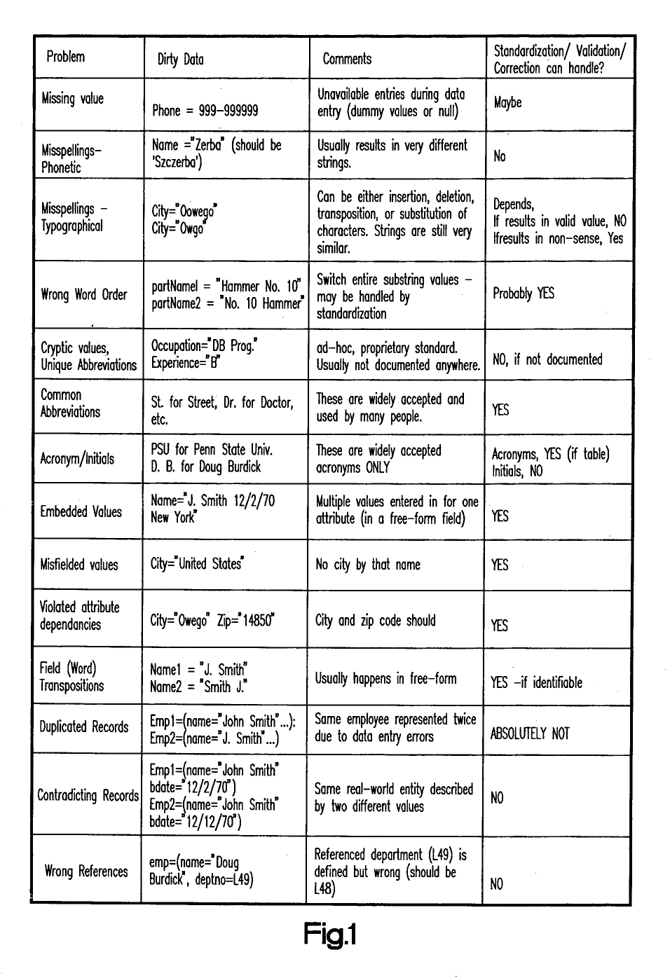

### DETAILED DESCRIPTION OF AN EXAMPLE EMBODIMENT

Ideally, a data cleansing application cleanses a record collection that may come from one or more sources. Although representing the same type of real-world entity, records from different sources may have different formats (i.e., different number and/or ordering of the record fields, etc.). Also, records may come from static sources (i.e., a database table, etc.) as well as dynamic sources (i.e., data streams, etc.).

Further, the quality of a cleansed result may be improved if the application utilized available additional information to refine the cleansing application. Also, the iteration of particular steps within the cleansing application may also improve the quality of the results.

A system in accordance with the present invention defines an architecture for performing a data cleansing operation on a collection of records. The architecture supports a framework for deriving additional information and a learning system for implementing the additional information to refine the data cleansing operation. The learning system utilizes this additional information to improve the results of the data cleansing application. The architecture also may allow the steps of the data cleansing application to be applied iteratively, if desired.

An example data cleansing system for use with the present invention identifies groups of records that have “similar” values in different records for the same field. “Similar” means that all of the records in the field set would have the same value if the data were free of errors. The example system may be robust to “noise” present in real-world data (despite best attempts at standardization, normalization, and correction). The example system may involve the application of sets of transform functions to the fields in each of the records. Additionally, the example system may create a data structure to store the similarity information of the associated records for each field.

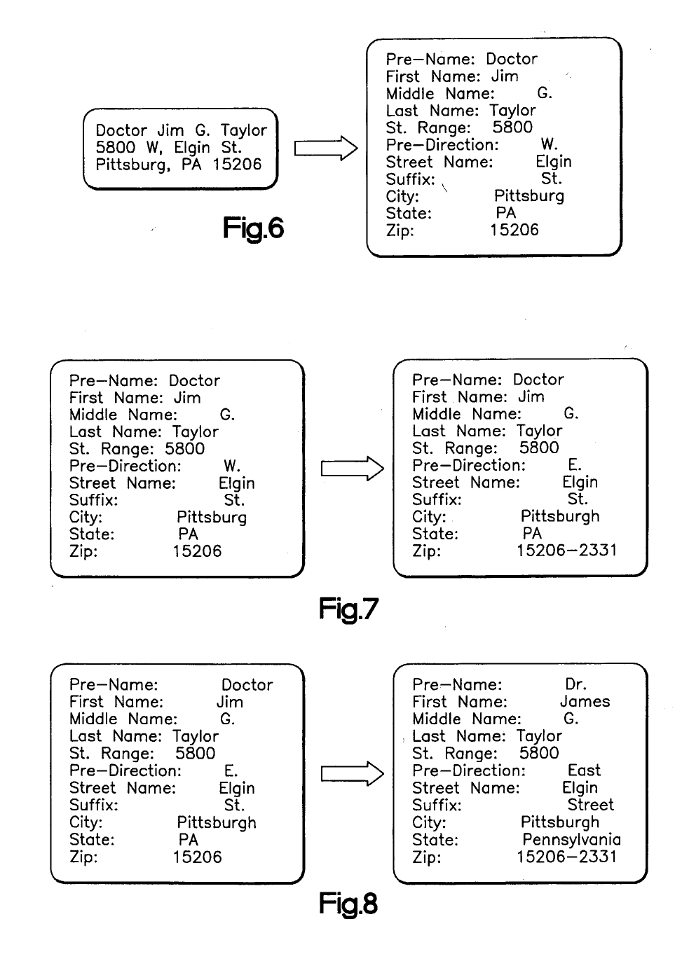

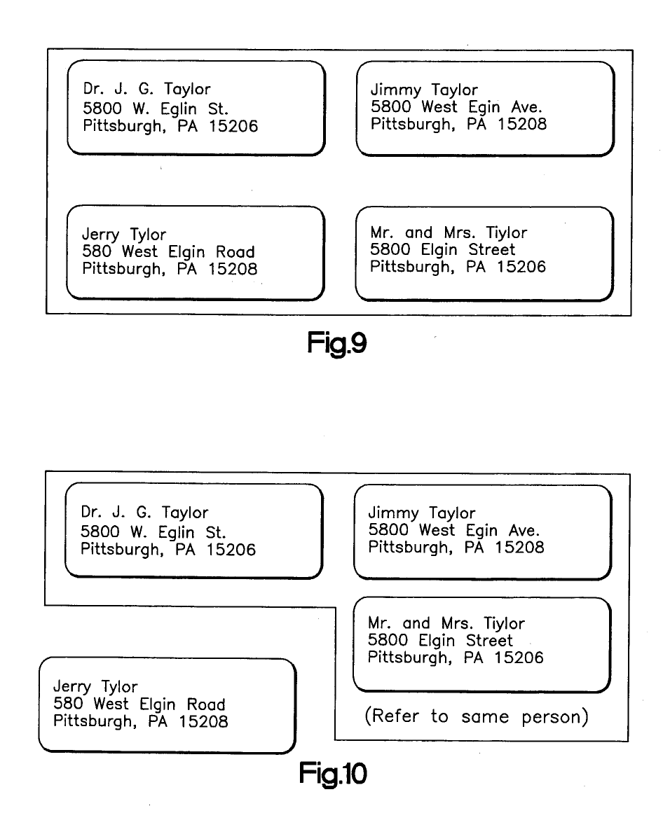

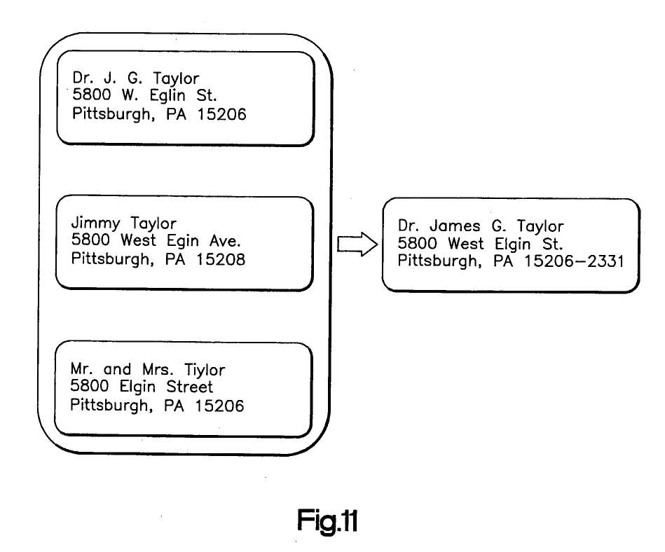

Typically, an example data cleansing process may be broken down into the following steps: parsing (FIG. 6); validation/correction (FIG. 7); standardization (FIG. 8); clustering (FIG. 9); matching (FIG. 10); and merging (FIG. 11). Note that different approaches may consolidate these steps or add additional ones, but the example system is essentially the same.

As viewed in FIG. 6, parsing may intelligently break a text string into the correct data fields. Typically, the data is not found in an easily readable format and a significant amount of decoding needs to be done to determine which piece of text corresponds to what particular data field. Note that this step does not involve error correction.

Records may be formatted or free-form. Formatted records have field values stored in a fixed order, and properly delineated. Free-form records have field values stored in any order, and it may be unclear where one field ends and another begins.

Once the string is parsed into the appropriate fields, the validation step, as viewed in FIG. 7, may check the field values for proper range and/or validity. Thus, a “truth” criteria must be provided as input to this step for each field.

The correction step may update the existing field value to reflect a specific truth value (i.e., correcting the spelling of “Pittsburgh” in FIG. 7). The correction step may use a recognized source of correct data such as a dictionary or a table of correct known values. For certain data, this step might not be feasible or appropriate and may be skipped.

As viewed in FIG. 8, the standardization step may arrange the data in a consistent manner and/or a preferred format in order for it to be compared against data from other sources. The preferred format for the data should be provided as input to this step.

As viewed in FIG. 9, the clustering step may create groups of records likely to represent the same entity. Each group of records is termed a cluster. If constructed properly, each cluster contains all records in a database actually corresponding to a unique entity. A cluster may also contain some other records that correspond to other entities, but are similar enough to be considered. Preferably, the number of records in the cluster is very close to the number of records that actually correspond to the entity for which the cluster was built.

As viewed in FIG. 10, the matching step may identify the records in each cluster that actually refer to the same entity. The matching step searches the clusters with an application specific set of rules and utilizes a computational intensive search algorithm to match elements in a cluster to the unique entity. For example, the three indicated records in FIG. 10 likely correspond to the same person or entity, while the fourth record may be considered to have too many differences and likely represents a second person or entity.

As viewed in FIG. 11, the merging step may utilize information generated from the clustering and matching steps to combine multiple records into a unique (and preferably the most correct) view of each entity. The merging step may fuse data from fields of different records into one record, thereby providing the most accurate information available about the particular entity. The intelligent merging of several records into a single consolidated record ideally creates a new record that could replace the duplicate record cluster it was generated from without loss of any information.

In the clustering and matching steps, algorithms identify and remove duplicate or “garbage” records from the collection of records. Determining if two records are duplicates involves performing a similarity test that quantifies the similarity (i.e., a calculation of a similarity score) of two records. If the similarity score is greater than a certain threshold value, the records are considered duplicates.

Most data cleansing approaches limit the number of these “more intensive” comparisons to only the “most promising” record pairs, or pairs having the highest chance of producing a match. The reasoning is that “more intensive” comparisons of this type are generally very computationally expensive to perform. Many record pairs have no chance of being considered similar if compared (since the records may be very different in every field), thus the expensive comparison step was “wasted” if we simply compare every pair of records. The trade-off for not performing the “more intensive” inspection for every record pair is that some matches may be missed. Record pairs cannot have high enough similarity scores if the similarity score is never calculated.

For an example description of a system for use with the present invention, assume the record data is given, including format of the data and type of data expected to be seen in each record field. The format and type information describes the way the record data is conceptually modeled.

Each record contains information about a real-world entity. Each record can be divided into fields, each field describing an attribute of the entity. The format of each record includes information about the number of fields in the record and the order of the fields. The format also defines the type of data in each field (for example, whether the field contains a string, a number, date, etc.).

The clustering step may produce a set of records “possibly” describing the same real-world entity. This set ideally includes all records actually describing that entity and records that “appear to” describe the same entity, but on closer examination may not. This step is similar to a human expert identifying similar records with a quick pass through the data (i.e., a quick pass step).

The matching step may produce duplicate records, which are defined as records in the database actually describing the same real-world entity. This step is similar to a human expert identifying similar records with a careful pass through the data (i.e., a careful pass step).

The concepts of correctness using the terms “possibly describing” and “actually describing” refer to what a human expert would find if she/he examined the records. An example system for use with the present invention is an improvement in both accuracy and efficiency over a human operator.

If constructed properly, each cluster contains all records in a database actually corresponding to the single real-world entity as well as additional records that would not be considered duplicates, as identified by a human expert. These clusters are further processed to the final duplicate record list during the matching step. The clustering step preferably makes few assumptions about the success of the parsing, verification/correction, and standardization steps, but performs better if these steps have been conducted accurately. In the clustering step, it is initially assumed that each record potentially refers to a distinct real-world entity, so a cluster is built for each record.

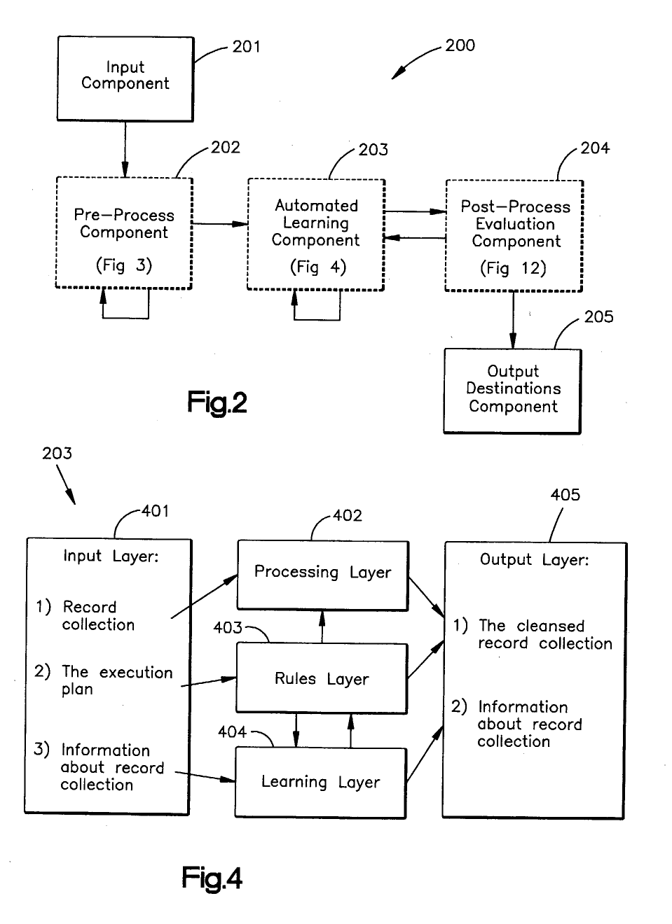

At the highest level, the architecture defined by the system 200 in accordance with the present invention may be represented as five components, as illustrated in FIG. 2. An input component 201 compiles the record collection to be cleansed. The input may come from multiple sources. Data from these sources may be either “clean” or “dirty”.

A pre-process component 202 prepares the data prior to entering the cleansing process. This component 202 also generates information that can be used to refine the cleansing process.

An automated learning component 203 performs the cleansing process. This component 203 also supports a learning system for refining the cleansing process (i.e., adjusting the algorithm parameters to allow for either a more efficient and/or more accurate solution).

A post-process evaluation component 204 evaluates the results of the cleansing process. The results are received from the automated learning component 203.

An output destinations component 205 outputs the results of the data cleansing process to one or more different destinations (i.e., a variety of data mining applications). The results include the cleansed record collection and information about how these results were obtained by the system 200.

The arrows in FIG. 2 connecting the components represent the directions information may flow between the architecture components. The collection of records input to the input component 201 may come from one or more sources. Input sources may be static (i.e., data marts, data warehouses, databases, flat files, etc.) or dynamic (data streams, output of an extraction-transform-load operation, etc.). Additionally, the input collections of records may have different formats. Different record sources may represent the records with a different number or ordering of the fields in each record. The record collection or collections are passed as input to the pre-processing component 202.

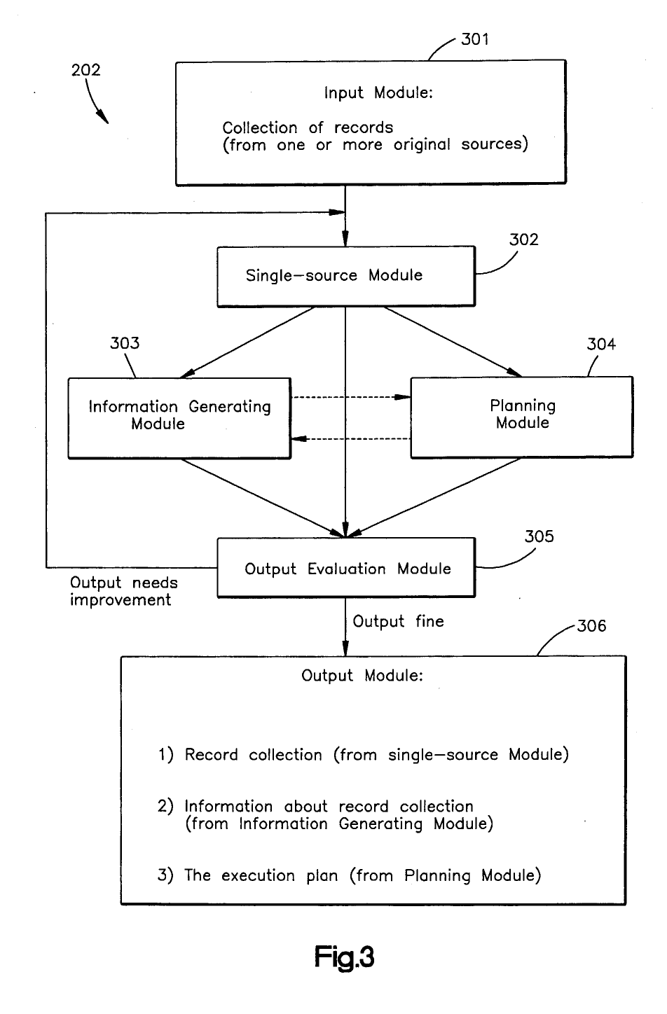

All of the records pass through the pre-processing component 202 before going to the automated learning component 203. As illustrated specifically in FIG. 3, the pre-processing component 202 is comprised of six modules. An input module 301 receives the collection(s) of records from the input component 201.

A single-source module 302 of the pre-processing component 202 makes the combined record collection “appear” to come from a single source. An example of this abstraction would be to provide buffers for record data from streaming sources, or making sure all of the records have a uniform format. The single-source module 302 allows the automated learning component 203 to process the collection as coming from a single source, even though this is not the case. Further, the single-source module 302 frees the automated learning component 203 from lower level tasks that would have to be performed if the collection comes from multiple physical sources.

An information generating module 303 of the pre-processing component 202 generates information about the record collection for input into the automated learning component 203. This generated information may be derived from the record collection itself. For example, statistics about the record collection (i.e., how many records come from a particular source, how many records share a particular value for a field, etc.) may be computed. Indices of different record fields may be built, or the records examined to determine the type of data in each record field (i.e., whether the data is alphabetic, numeric, a calendar date, etc.) Available information outside of the record collection itself may also be used. Examples may include how record data was entered (i.e., whether the record data was taken over the phone, typed into the system at a keyboard, OCRed into the system, etc.), the source of the record, or metadata about the record fields.

A planning module 304 of the pre-processing component 202 estimates the resources needed to cleanse the record collection and create an execution plan for the cleansing process. The execution plan describes, in detail, how the cleansing process will be performed, and may also suggest what structures should be built to improve either the accuracy or efficiency of the overall system (i.e., indices on certain record fields may be added). The planning module 304 also estimates the necessary resources (i.e., CPU time, memory, disk space, etc.) to perform the cleansing process by using information about the record collection. The planning module 304 may also include an optimizer to suggest the most efficient plan based on the most important metric, as defined by a user. For example, if memory is limited, a plan that uses less memory, but takes longer, may be desired.

An output evaluation module 305 of the pre-processing component 202 evaluates the output of the three other functional modules 302, 303, 304. If the output is determined to be satisfactory, the output is passed to the automated learning component 203 via an output module 306. If the output is determined to be unsatisfactory (i.e., based on pre-defined thresholds, application-specific metrics, etc.), the three other functional modules 302, 303, 304 may be run again with different parameters. The output evaluation module 305 also may provide suggestions on how to change the execution of the three other functional modules 302, 303, 304 to improve the quality of the output (i.e., a feedback loop).

Each functional module 302, 303, 304 of the pre-processing 202 component may interact with each of the other three functional modules 302, 303, 304, as illustrated in FIG. 3. The input module 301 passes the record collection to the single-source module 302. The single-source module 302 may provide output to the information generating module 303, the planning module 304, and/or the output evaluation module 305. During processing, the information generating module 303 and the planning module 304 may share information. The output of the information generating module 303 and the planning module 304 is evaluated by the output evaluation module 305. If the output needs to be modified as determined by the output evaluation module 305, the single-source module 302, the information generating module 303, and the planning module 304 may be run again. Otherwise, the output module 306 receives the output. The output of the output module 306 of the pre-processing component 202 comprises the record collection (abstracted to appear as a collection from a single source), the additional information generated to help refine (and optimize) the cleansing process, and the execution plan (detailed plan to perform the cleansing process from the planning module 304).

The automated learning component 203 performs the actual cleansing process. Additionally, the cleansing process may be further refined within the automated learning component 203. The automated learning component 203 receives three outputs from the pre-processing component 202 at the input layer 401. These outputs are the record collection, the execution plan, and information about the record collection.

A processing layer 402 of the automated learning component 203 performs the cleansing process on the record collection by implementing predefined algorithms. Each step of the cleansing process is controlled by a set of rules defined in a rules layer 403 (i.e., defining the proper execution for each step).

The rules layer 403 defines the execution of the cleansing process. Each processing layer section has a corresponding rules layer section in the rules layer 403. Each rules layer section contains the rules for controlling the execution of the corresponding processing layer section. For each step of any cleansing process, the rules define the requirements for each step for automated evaluation. For example, the rules controlling the clustering section determine how the clustering module should build the clusters for each real-world entity represented in the record collection.

The rules for each step are derived initially from an execution plan (given as input to the automated learning component 203), and are refined by input from a learning layer 404 for that step during the data cleansing process. Since each step of the data cleansing process has different requirements, the rules to perform each of the steps may take different forms. Rules may be given as Boolean expressions, IF-THEN statements, threshold values, etc.

The learning layer 404 refines the rules to improve the quality of the cleansed result. Since the rules control the cleansing process, the rules need to accurately reflect the cleansing requirements for the cleansing process in order to have high quality results. The refinements to the rules in the rules layer 403 are based on a combination of the information about the record collection (given as input to the automated learning component 203) and information generated during execution of the cleansing process. The learning layer 404 uses this information to improve the existing rules by using a learning mechanism that generates/modifies rules in the appropriate form. Examples of learning mechanisms would include, but are not limited to, the following: neural nets, decision trees, and knowledge bases, etc. The learning mechanisms are determined by the particular data cleansing application, as well as which step of the cleansing process is being performed. Each rules section of the rules layer 403 has a corresponding learning section in the learning layer 404.

The rules layer 403 and the learning layer 404 share information in both directions. The current rules are used by the learning layer 404 to generate new improved rules, while the rules layer 403 only provides control information in one direction to the processing layer 402.

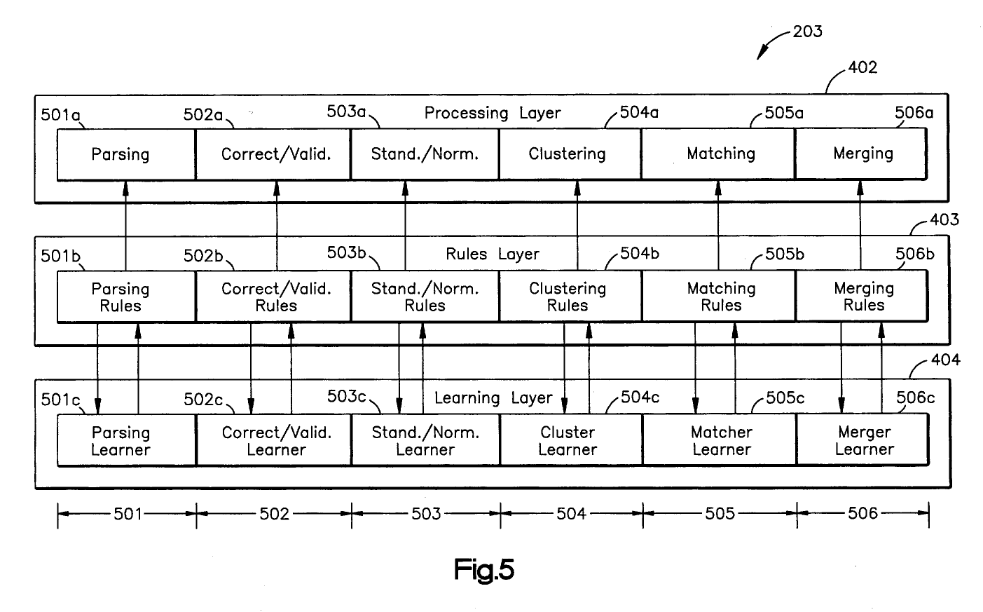

The processing (or algorithmic) layer 402 of the automated learning component 203 may perform six different steps, as illustrated in FIG. 5. Each of these steps may be performed by a separate section.

A parsing module 501 intelligently divides a text string into the correct data fields, as illustrated in the example of FIG. 6. Most times the data is not found in an easily readable format and a significant amount of decoding needs to be done to figure out which piece of text corresponds to what particular data field. Note that this step does not involve error correction. Records may be formatted or free form. Formatted records have field values stored in a fixed order, and properly delineated. Free-form records have field values stored in any order. It may not be clear where one field ends and another begins. The parsing module 501 includes a parsing section 501a of the processing layer 402, a parsing rules section 501b of the rules layer 403, and a parsing learner section 501c of the learning layer 404.

Once the string is parsed into the appropriate fields, a correction/validation module 502 determines whether the field values are in the proper range and/or the field values are valid, as illustrated in the example of FIG. 7. This may only be performed if there exists some sort of “truth” criteria for the given field. The correction/validation module 502 further updates the existing field value to reflect a specific truth value (i.e., correcting the spelling of “Pittsburgh” in FIG. 7). For certain data, this step may not be feasible/appropriate and may be skipped. The correction/validation module 502 includes a correction/validation section 502a of the processing layer 402, a correction/validation rules section 502b of the rules layer 403, and a correction/validation learner section 502c of the learning layer 404.

A standardization module 503 arranges the data in a consistent manner and/or a preferred format in order for the data to be compared against data from other sources, as illustrated in the example of FIG. 8. The standardization module 503 includes a standardization section 503a of the processing layer 402, a standardization rules section 503b of the rules layer 403, and a standardization learner section 503c of the learning layer 404.

A clustering module 504 clusters groups of records likely to represent the same entity. If constructed correctly, each cluster contains all records in a collection actually corresponding to a unique entity. A cluster may also contain some other records that correspond to other entities, but are similar enough to be considered. Ideally, the number of records in the cluster is very close to the number of records that actually correspond to the entity for which the cluster was built, as illustrated in the example of FIG. 9. The clustering module 504 includes a clustering section 504a of the processing layer 402, a clustering rules section 504b of the rules layer 403, and a clustering learner section 504c of the learning layer 404.

A matching module 505 identifies the records in a cluster that actually refer to the same entity. The matching module 505 searches the clusters with an application specific set of rules and uses a more computational extensive search algorithm to match elements in a cluster to the unique entity, as illustrated in the example of FIG. 10 (i.e., the three indicated records likely correspond to the same person, while the fourth record was considered to have too many differences and likely represents a another person). The matching module 505 includes a matching section 505a of the processing layer 402, a matching rules section 505b of the rules layer 403, and a matching learner section 505c of the learning layer 404.

A merging module 506 uses the information generated from the clustering and matching modules 504, 505 to combine the multiple records into a unique, preferably more correct, view of each entity. The merging module 506 may fuse data from different records into one record thereby providing the most accurate information available about the particular entity, as illustrated in the example of FIG. 11 (i.e., the intelligent merging of the records into a single consolidated view). This one record represents a new record that could replace the duplicate record set if it was generated without loss of any information. Conceptually, this view represents a new record replacing the duplicate record set from which it was generated without loss of any information. The merging module 506 includes a merging section 506a of the processing layer 402, a merging rules section 506b of the rules layer 403, and a merging learner section 506c of the learning layer 404.

Each layer 402, 403, 404 in the automated learning component 203 has a separate section to support each of the steps, as illustrated in FIG. 5. Generally, the processing layer 402 will execute the steps in the order presented, with the output of the previous step becoming input to the subsequent step. However, the rules section for a particular processing section may determine that the section needs to be repeated or that a previous section has to be run again (e.g., the results of the prior section need to be improved by running the section again with refined rules).

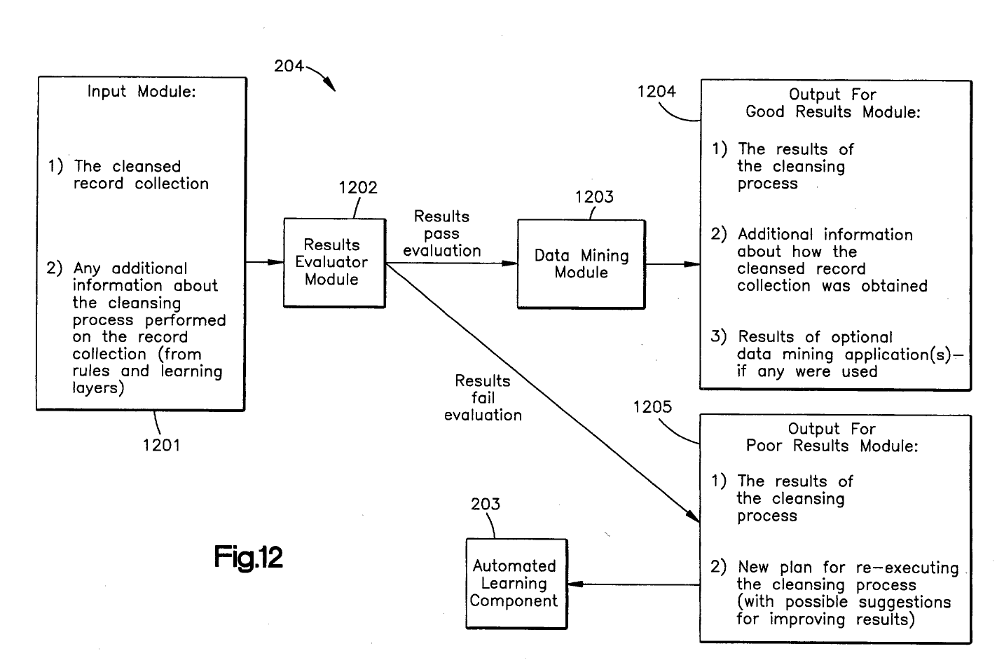

The post-processing evaluation component 204 receives the cleansed data collection and the additional information from the automated learning component 203. The post-processing evaluation component 204 includes an input module 1201, a results evaluator module 1202, a data mining module 1203, an output for good results module 1204, and output for poor results module 1205, as illustrated in FIG. 12. The input module 1201 receives the cleansed record collection and additional information about the cleansing process performed on the record collection (i.e., information from the rules layer 403 and the learning layer 404)

The results evaluator module 1202 evaluates the cleansed record collection received from the input module 1201. Available quality metrics may be used to evaluate the cleansed result at this point. Quality metrics measure the accuracy of the cleansing process. If the results evaluator module 1202 determines that the quality of the result is too low, it may decide to iterate the process again and give feedback to improve the subsequent iteration (i.e., feedback to the automated learning component 203). If the results evaluator module 1202 determines that the quality of the result is high enough, then the cleansed result is passed to any data mining applications present (i.e., an optional data mining module 1203).

The data mining module 1203 may mine the cleansed record collection for useful trends and/or patterns. This data mining only occurs if the results of the cleansing process are determined to be of high enough quality by the results evaluator module 1202. The data mining module 1203 may be used to generate statistical data on the cleansed record collection as well.

The output from the post-process evaluation module 204 may be output to one or more destinations 205 (FIG. 2) through the output for good results module 1204 or the output for poor results module 1205. Possible destinations for good results may include domain-specific applications, data marts, data warehouses, and/or operational data stores. The results from the post-process evaluation module 204 may include the cleansed record collection, additional information about the cleansed collection (including statistics about the collection), and results from any optional data mining applications run on the cleansed results. A possible destination for poor results is back to the automated learning component 203 for more cleansing.

From the above description of the invention, those skilled in the art will perceive improvements, changes and modifications. Such improvements, changes and modifications within the skill of the art are intended to be covered by the appended claims.

Having described the invention, the following is claimed:

1. A system for cleansing data, said system comprising:
an input component for receiving a collection of records;
a pre-process component for formatting the collection of records, said pre-process component creating a plan for cleansing said collection of records;
an automated learning component for performing said plan, said automated learning component modifying said plan based on feedback from intermediate steps within said plan; and
a post-process evaluation component for evaluating the result of said automated learning component, said post-process component determining whether to accept the result or to feed back the result to said automated learning component.

2. The system as set forth in claim 1 wherein said pre-process component includes a single source module for making the collection of records appear to come from a single source.

3. The system as set forth in claim 1 wherein said pre-process component includes an information generating module for generating statistics about the collection of records.

4. The system as set forth in claim 1 wherein said pre-process component includes a planning module for creating said plan.

5. The system as set forth in claim 1 wherein said pre-process component includes an output evaluation module for evaluating the results of the pre-process component and determining whether to run the pre-process component again.

6. The system as set forth in claim 1 wherein said automated learning component includes a processing layer for performing said plan.

7. The system as set forth in claim 1 wherein said automated learning component includes a rules layer for modifying said plan in order to perform the cleansing of the collection of records more accurately and more efficiently.

8. The system as set forth in claim 1 wherein said automated learning component includes a learning layer for providing information to modify said plan in order to perform the cleansing of the collection of records more accurately and more efficiently.

9. The system as set forth in claim 1 wherein said post-process evaluation component includes a results evaluator module for determining whether to return the result of the data cleansing back to the automated learning component.

10. The system as set forth in claim 1 wherein said system provides an output comprising the cleansed collection of records, information regarding how the cleansed collection of records was derived, and results of data mining operations.

11. A method for cleansing data, said method comprising the steps of:
providing a collection of records, an execution plan, and information about the collection of records;
generating a set of rules from the execution plan;
beginning the process of cleansing the collection of records utilizing the set of rules;
modifying the set of rules with the information about the collection of records and feedback from said beginning step; and
continuing the process of cleansing the collection of records with the modified set of rules.

12. The method as set forth in claim 11 wherein a processing layer continuously interacts with a rules layer during the cleansing of the collection of records in order to optimize the functioning of said method.

13. The method as set forth in claim 11 wherein a rules layer continuously interacts with a learning layer during the cleansing of the collection of records in order to optimize the functioning of said method.

14. The method as set forth in claim 11 further including the step of formatting the collection of records so that the collection of records appear to have come from a single source.

15. A method for cleansing data, said method comprising the steps of:
inputting a collection of records;
formatting the collection of records so that the collection of records appears to come from a single source;
generating information about the collection of records regarding size, composition, and type of records;
creating an execution plan for cleansing the collection of records;
evaluating the output from said formatting, generating, and creating steps; and
determining whether to perform said formatting, generating, and creating steps again based on said evaluating step.
